(19) United States
(12) Patent Application Publication
(10) Pub. No.: US 2025/0067765 A1
(43) Pub. Date: Feb. 27, 2025

(54) SYSTEMS AND METHODS FOR CARRYING OUT HIGHLY MULTIPLEXED BIOANALYSES

(71) Applicant: Nautilus Subsidiary, Inc., Seattle, WA (US)

(72) Inventors: Shunqiang WANG, Foster City, CA (US); Ezra VAN GELDER, Palo Alto, CA (US); Patrick LEUNG, San Bruno, CA (US); Daniel HORNER, Seattle, WA (US)

(21) Appl. No.: 18/723,016

(22) PCT Filed: Dec. 20, 2022
(86) PCT No.: PCT/US22/82022

§ 371 Date: Jun. 21, 2024

Related U.S. Application Data
(60) Provisional application No. 63/292,676, filed on Dec. 22, 2021.

(51) Int. Cl. G01N 35/10

(52) U.S. Cl. CPC G01N 35/1067; G01N 35/1002; G01N 35/1009; G01N 35/1097

(57) ABSTRACT

Methods and systems for analysis of large numbers of analytes using large numbers of reagents and processes using multiplexed, independent systems and subsystems for efficient processing and increased throughput of biological analyses.

### CROSS-REFERENCE TO RELATED APPLICATION

This application claims priority to U.S. Provisional Patent Application No. 63/292,676, filed Dec. 22, 2021, which is entirely incorporated herein by reference.

### BACKGROUND

Scientific analyses have undergone rapid and revolutionary changes over the past several decades. Biological and chemical analyses in particular have benefitted from technological advances that allow analyses of previously unseen processes and reactions, dramatically improved sensitivity, and massively increased throughput and multiplexing.

As just one example, the analysis of nucleic acids has progressed by leaps and bounds over the past several decades, from visual analysis of crude separation gels where one might read 50 or 100 bases of sequence in a lengthy, labor intensive experiment, to fully automated sequencing systems that are able to sequence a substantially complete human genome in a matter of hours.

As these analytical technologies have advanced, the number and sensitivity of the various operations to be performed by processes and systems carrying out these analyses has had to dramatically increase, from the detection of individual nucleotides being added to synthesized nucleic acid strands, to vast arrays of different molecules being analyzed through sequencing or hybridization analysis.

As researchers seek to analyze portions of the biome that are more relevant, more telling, and more contemporaneous than the genome or even the transcriptome, the sheer scope of the analytes that need to be measured increases dramatically. Likewise, the sensitivity and number of operations to be performed by analytical systems also dramatically increases. What is needed is for that increase in system complexity, sensitivity and numbers of operation to be achieved without resulting in an equivalent increase in processing time and cost. The present disclosure provides processes, methods and systems that accomplish these and other objectives.

### SUMMARY

The present disclosure provides systems and processes that provide improved efficiencies particularly in complex analytical operations using multi-faceted analytical system. These processes and systems include benefits of multiplexed resources, improved accessibility for those resources, and efficient staging and scheduling of resource use, in improving overall efficiencies of these analytical processes. In some cases, systems may include duplicate independent resources of a given type, such as fluidics, detection and the like. Alternatively or additionally, these systems may provide for accessibility for these resources to system components through multiple access points and/or through improved access points so as to avoid interference with other resources, and further may additionally or alternatively benefit from improved staging and scheduling of the application of these various resources to the overall operation, in order to improve its efficiency.

In some cases, provided herein are analytical systems that comprise a flowcell device that comprises at least a first flowcell unit. An analyte array may be disposed in the flowcell unit that comprises a plurality of different analytes immobilized on a surface of the array in individually addressable locations. The system may also comprise at least first and second independent fluidic systems configured to deliver fluid reagents to the flowcell unit independently of each other, where the first fluidic is being configured to be fluidically coupled to a source of a first set of reagents, and the second fluidic system is configured to be fluidically coupled to a source of a second set of reagents. The use of multiple fluidic systems allows for delivery of fluid reagents at different times, to different places, and at different volumes, flow rates and other conditions.

In other cases, provided are methods for analyzing a plurality of analytes, which comprise providing a plurality of different analytes on a plurality of different arrays, where the arrays are disposed within each of a plurality of flowcell units in a flowcell device. The methods may involve performing a first interrogation reaction process in a first subset of the plurality of flowcell units, performing a second interrogation reaction process in a second subset of the plurality of flowcell units, and detecting results of the first interrogation reaction process in the first subset of flowcell units concurrently with performing the second interrogation reaction in the second subset of flowcell units. This allows for increased efficiency of process by multitasking the analytical and fluidic systems in a highly multiplexed system.

Additionally, in some aspects, disclosed herein are methods of analyzing results of a plurality of reactions, that comprise performing a first reaction in a first flowcell unit in an integrated flowcell device, analyzing a result of the first reaction in the first flowcell unit, performing a second reaction in a second flowcell unit in the integrated flowcell device, and analyzing a result of the second reaction in the second flowcell unit. In some cases, the time between performing the first reaction and analyzing the results of the first reaction, and the time between performing the second reaction and analyzing the results of the second reaction are substantially equal as described in greater detail herein.

In still other aspects, provided herein are methods for analyzing a plurality of analytes that comprise providing a plurality of flowcell units in a flowcell device, each flowcell unit having an array of analytes disposed therein. The methods may include performing an interrogation reaction process on the arrays of analytes in each of a subset of flowcell units in the plurality of flowcell units by passing one or more interrogation reagents through each subset of flowcell units. Results of the interrogation reagents on the analytes are serially detected in the arrays in each of a plurality of subsets of the flowcell units. The steps of performing the reaction and detecting steps are repeated on each subset of the plurality of flowcell units. As provided herein, the performing steps and the detecting steps may be staged such that an elapsed time between the performing step and the detecting step for any flowcell unit is substantially equivalent.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

FIG. 1 shows a generalized schematic illustration of an example of an overall system as described herein.

FIG. 2 shows a schematic illustration of an example of a component set of subsystems of the overall systems described herein including independent fluidic systems and detection systems.

FIG. 3 shows a schematic illustration of an example of dual independent fluidic systems for addressing a flowcell device.

FIG. 4 shows a schematic illustration of an example of a fluid inlet/outlet port configuration for a flow channel.

FIG. 5 shows a schematic illustration of a fluidic system or system module for aliquoting reagents into a flowcell system when separated by spacer fluids or air bubbles.

FIG. 6 illustrates an example of a timing profile of operations carried out in a multiplexed flowcell.

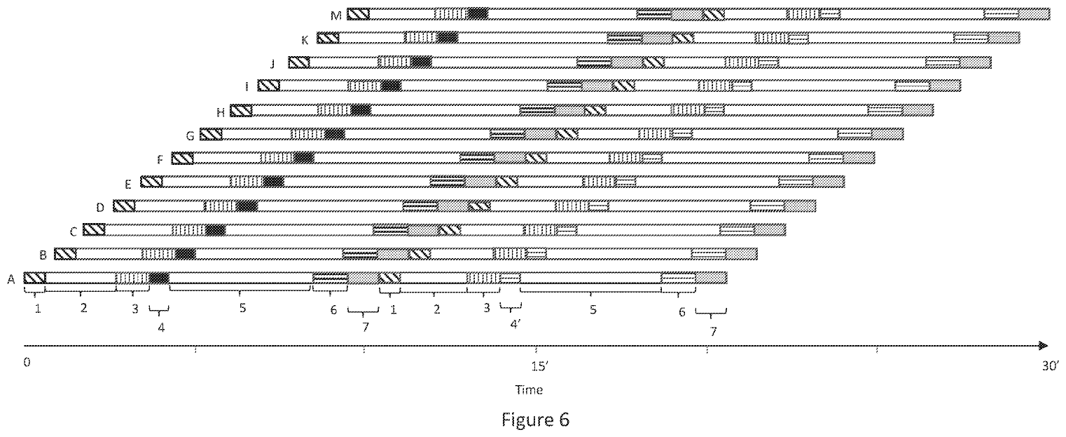

### DETAILED DESCRIPTION

### I. General

Described herein are processes, methods and systems that are useful in performing large numbers of biochemical operations on samples to be analyzed that may include large numbers of different analytes. The processes, methods and systems are configured to be able to carry out these operations and analyses in an efficient manner, reducing the amount of time, the number of steps, and/or the amounts of precious reagent materials, and consequently, the costs associated with carrying out such analyses.

The approaches described herein generally revolve around analyses of relatively large numbers of samples or sample components through interrogation by relatively large numbers of analytical reagents and/or under relatively large numbers of physical, chemical and/or environmental conditions, and then measuring or detecting the impacts of those interrogations in order to characterize the samples or their components. As will be appreciated, analyses that seek to perform many operations using many reagents against many analytes will typically face challenges associated with such scales, including challenges of throughput, space and cost.

As described in greater detail below, the described approaches involve relatively large multiplexes of more than one component of the analysis, interrogation and/or detection. As such, the systems and methods included herein provide gains in efficiencies in terms of multiple parameters, such as time for analysis, quantities of materials used, including both samples and reagents, process steps, space requirements, and ultimately, expense.

### II. Overview

The systems and methods described herein are generally directed to analysis of large numbers of analytes by using large numbers of reagents to interrogate the analytes, and subsequently analyze the impact of those interrogation reagents on the analytes in order to characterize those analytes, and potentially the samples from which they were obtained. As used herein, analytes could potentially be any of a variety of different sample types or sample component types that one may desire to analyze and/or characterize. For example, such analytes may potentially include, for example, chemical entities, biochemical entities, cellular entities or components thereof, e.g., organelles, tissue samples, or even organisms, e.g., microorganisms. In certain particular cases, and for ease of discussion, preferred analytes may include molecular species, such as biochemical entities of interest in evaluating and characterizing biological systems, such as nucleic acids (DNA, RNA), proteins, polypeptides, polysaccharides, or other biochemically interesting chemical and/or biochemical species.

In a general sense, the approaches described herein provide for individual analytes, analyte types, and/or analytes derived from common samples, that are segregated from each other into different segments of an analysis device, e.g., a flowcell, a fluidic channel array, array substrate, cartridge, or other analysis vessel, in order to provide for their separate interrogation and detection. The segregated analytes may then be individually addressed from a detection standpoint, whether optically, electronically, or otherwise. Additionally, in order to provide enhanced efficiency in cases of large numbers of analytes and large numbers of reagents used in interrogating such analytes, the analytes, and/or subsets of analytes may be independently addressed by two or more different fluidic sources, in order to deliver different fluid compositions, different fluid amounts, or different fluid conditions, e.g., temperature, flow rate, or the like, to the different segregated analytes or sets of such analytes, either at different times or concurrently. Accordingly, in some cases, such independent fluidic sources and/or systems may separately and independently address the individual segregated or segmented analytes or sets of analytes.

As alluded to above, in some cases, the detection systems that may be employed in the described approaches also permit independent and individual addressability of the analytes and/or sets of analytes, which allows for detection processes that may be carried out with individual analytes or sets of analytes simultaneously with the fluidic operations or other interrogation or other operations of other analytes or sets of analytes within a given analytical unit, e.g., a flowcell, fluidic channel array, array substrate, cartridge, or other analysis vessel. As a result of such a configuration, one may optimize multistep processes by staging one or more different unit operations in one segmented set of analytes, e.g., performing one or more fluidic operations such as chemistry or biochemistry steps on such segmented analytes, while simultaneously carrying out different unit operations, e.g., detection or other unit operations on analytes in other segments.

In addition to the above, the approaches herein described may additionally provide individual and independent addressability of one or more additional different inputs to the different segments. Examples of such inputs include, for example, thermal inputs, optical inputs, e.g., illumination, whether for detection purposes or otherwise, mechanical inputs, electrical inputs, magnetic inputs, and the like. Likewise, separate segments may additionally, in some cases, be separately accessible, e.g., for purposes of extracting samples or components, or analytes exposed to or reacted with the samples or components.

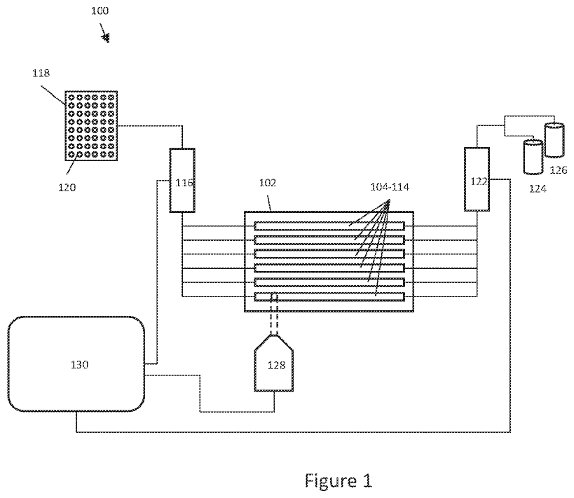

An example of the overall systems described herein is schematically illustrated in FIG. 1. As shown, the system 100 includes an analysis device, such as flowcell 102, upon which discrete samples or sample components are provided segregated into separate locations, e.g., as arrays of analytes. As shown, the flowcell device 102 includes multiple discrete flowcell units, flowcell lanes or channels 104-114. Within a given flowcell unit may exist multiple channels that include discrete arrays, but that are fluidically interconnected, e.g., so that reagents may be introduced to such flowcell channels or lanes simultaneously through a single access port. Additionally or alternatively, a flowcell device may include multiple discrete flowcell units integrated into a single device structure or housing, but where each flowcell unit (optionally including multiple interconnected flowcell lanes or channels) is discrete from each other flowcell unit (itself optionaly including multiple flowcell lanes or channels). The system also includes at least a first fluidic system 116, which is connected to each of the flowcell units, lanes or channels, individually, or in some cases, concurrently. Typically, the fluidic system 116 may include a pumping system for driving the flow of fluids through the fluidic system and into the flowcells at a desired flow rate, volume and direction. Such pumping systems may include positive pressure systems, including, for example, syringe pump systems, pressurized systems, peristaltic pumping systems or the like. Alternatively, negative pressure systems may be used to draw fluids into chambers or channels within the overall system. Additionally, the fluidic system may include valving mechanisms in order to control the fluidic access to the different lanes.

Fluidic system 116 is also fluidically connected to a source of a number of interrogation reagents, e.g., such source shown as a multiwell plate 118 that includes multiple different interrogation reagents within the separate wells 120. Again, the fluidic system may include one or more of a manifold system for fluidically accessing different reagents within the source 118 at any given time. Alternatively, the fluidic system 116 may include a pipetting system for drawing reagents from the different reagent sources at different time.

A second fluidic system 122 is shown also connected to the multiple flowcell units, lanes or channels 104-114. As above, the fluidic system will typically include a fluid pumping system that may include positive or negative pressure pumping systems as described above. As above, the fluid connection between the second fluidic system and the flowcells may include valving mechanism(s) in order to control direction of fluids into different flowcell units lanes or channels. The fluidic system 122 is also shown fluidically connected to sources of other reagents 124 and 126, e.g., wash reagents, etc., that are to be delivered to the flowcellu units, lanes or channels. As with above, the fluid connection may be via a manifold and valving system, or it may include a pipetting system, for controlling the reagents to be pumped at any given time by the second fluidic system 122.

The system shown in FIG. 1 also includes a detection system, shown as an optical detection system 128, for analyzing the different samples or sample components within the various flowcell units, lanes or channels, e.g., for measuring detectable characteristics of samples in the flowcells.

The systems typically include control and processing systems as well, e.g., controller/processor 130, which may serve to control the operation of the fluidic systems, and detection systems included in the overall system. Likewise, the controller/processor may also serve to store and process analytical data received from the detection system 128.

The systems and methods described herein may generally be particularly useful in high throughput biochemical analysis systems, such as protein characterization systems like those described in, e.g., U.S. Patent Nos.

The different components of the methods and systems are generally described in greater detail below.

### III. Segmenting Samples or Components

As noted above, in the approaches described herein, multiple analytes or sets of analytes may generally be provided segregated from each other, as opposed to being provided mixed in a bulk solution or format, in order to allow individual analysis of the individual analytes, analyte types or sets of analytes. In chemical, biochemical and biological analyses, a number of different methods exist for segregating these different samples or components for discrete analysis, and one or more of these may be used in segregating or segmenting samples or sample components as described herein.

For example, in some cases, liquid based analytes or sets of analytes may be provided segregated into discrete wells in multiwell plates or substrates. These plates may include anywhere from tens to hundreds to thousands of discrete wells in which discrete samples or sample components may be deposited and separately interrogated and/or analyzed while remaining separated from their neighboring samples or components.

In other cases, different analytes or sets of analytes may be provided in different fluidic channels or lanes in a fluidic or microfluidic manifold or device. Those samples may be provided immobilized, e.g., on an interior surface of the channel or lane or on the surface of a particle, such as a bead or other matrix that is disposed within the channel, lane or well, or they may be maintained in solution and exposed to different reagents or reaction conditions within those lanes.

In still other cases, analytes may be provided segregated and immobilized or otherwise constrained onto different positions on the surface of a substrate in an array format, e.g., with different analytes or subsets of analytes provided in different positions on the array that may be separately analyzed. In cases of such arrays, while samples or components may be constrained by physical barriers, e.g., raised surfaces, hydrophilic or hydrophobic regions, or the like, in many cases, the samples or components may additionally or alternatively be provided immobilized in different regions of the array. Such immobilization may be random, or may be ordered, through a patterned immobilization process, provided that the components are individually addressable for the given purpose, e.g., detection and/or interrogation or application of other inputs, as discussed elsewhere herein. A wide range of approaches are available to immobilize analytes upon substrate surfaces, including covalent attachment to the surface or compounds associated or attached thereto, ionic attachment or association, affinity attachments or association with complementary moieties on the surface, and the like.

In certain particular aspects, the approaches described herein utilize an array approach to segmenting analytes. By way of example, in at least one approach, a collection of different proteins or polypeptides from a given sample may be provided immobilized and arrayed in different locations on a substrate where individual protein molecules are provided localized within discrete regions of the substrate surface, such that each such individual protein molecule may be independently addressed by a detection system. Examples of such single molecule protein or polypeptide arrays are described in, for example, U.S. Patent Application No. 2021-0101930, and U.S. Pat. Nos. 10,473,654, and 10,948,488, the full disclosures of which are hereby incorporated herein by reference.

Briefly, such single molecule protein or polypeptide arrays typically provide individual protein or polypeptide molecules localized within discrete regions of the substrate surface while providing sufficient space between such individual molecules to allow for independent interrogation of those proteins molecules, and detection of the results of that independent interrogation. For example, where optical detection is used to observe the results of an interrogation reaction, e.g., through the binding of a fluorescently labeled affinity reagent, the arrayed proteins or polypeptides may be positioned such that they may be optically resolvable from each other by the detection system.

A variety of methods may be employed to localize individual protein or polypeptide molecules to discrete regions on a substrate. For example, in some cases, an entire substrate surface may be derivatized to provide surface bound active binding or linking groups to which individual proteins may be coupled. Solution containing the various protein molecules may then be contacted with the surface under appropriate conditions to allow for coupling of the proteins to the binding groups. In order to provide for appropriate spacing between individual molecules, the deposition process may be carried out under sufficiently dilute conditions such that the resulting individually immobilized molecules are sufficiently separated. As will be appreciated, such dilution-based approaches, while functional, may not be ideal for optimizing the number of coupled molecules on the array surface, as ensuring sufficient spacing for all may require excessive spacing in many or most cases.

In certain cases, a substrate surfaces may be functionalized in a defined pattern, e.g., in a gridded, lined, or other format, such that regions in which sample components are immobilized will be similarly ordered or arranged. Typically, such functionalization may result in defined derivatized zones that are separated by non-derivatized barriers or “streets” that separate them. In some cases, the barrier zones or streets may be differentially derivatized to more affirmatively prevent immobilization, such as through the use of hydrophobic zones or zones that have surface charges that repel immobilization of the sample components, or through incorporation of capping groups or chemistries, that prevent or significantly reduce the possibility of binding by proteins.

In some cases, arrayed proteins may be coupled to the surface using spacer molecules to which an individual protein or polypeptide is attached, where the spacers may provide the requisite spacing between protein molecules, despite the spacers being tightly packed on a surface. Such spacers may include any of a variety of compositions that may provide a selectable and reasonably controlled size, such as solid organic or inorganic particles, large macromolecular species, and the like. Examples of solid particles include, for example, polymer nano or microbeads, semiconductor nanocrystals, and similar compositions. In certain cases, large macromolecular compositions are used as the spacers, as they may be synthesized to possess relatively well controlled sizes and chemical make-up, and further provide advantages in terms of being able to selectively be coupled to individual protein molecules.

For example, in some cases, spacers may comprise nucleic acid molecules that form a relatively large macromolecular structure or particle. In some cases, such nucleic acids may be randomly entangled single or double stranded nucleic acids, while in other cases, these nucleic acid molecules may comprise an ordered structure, such as nucleic acid origami structures. As noted above, nucleic acid structures may be synthesized to provide desired characteristics, such as overall size of the structure, surface association characteristics, and even individual coupling moieties to couple a single protein or polypeptide molecule from a sample. Examples of these types of structures are described in, for example, U.S. Patent Application No. U.S. Patent Application No. 2021-0101930, the full disclosure of which is incorporated herein by reference in its entirety for all purposes.

The arrays described herein may include a large number of different analytes immobilized on the surface in order to be able to fully characterize the diversity of analytes present, e.g., in a sample, by identifying or characterizing the different analytes present. As such, for analyses that are examining complex samples comprising large numbers of different analytes, e.g., a biological sample comprising large numbers of proteins and/or polypeptides, arrays may be configured to have large numbers of different analytes present in order to characterize that diversity.

The arrays described herein may generally be configured to present massive numbers of analytes immobilized upon their surfaces such that each analyte is individually addressable. In particular, arrays may be employed that have at least 10⁵, 10⁶, 10⁷, 10⁸, 10⁹, 10¹⁰, 10¹¹, 10¹² or more individual analytes immobilized thereon in discrete locations. In particular, in some cases, individual analyte molecules may be provided disposed on a substrate surface in a manner that allows such individual molecules to be separately addressed, e.g., detected, observed, etc., from other individual analyte molecules on that surface.

While the arrays described herein may include millions or billions of individual analytes immobilized on their surfaces, for many analyses, the population of analytes may reflect a smaller number of distinct types of analytes, although present in different quantities in the sample. In particular, the arrays described herein may typically include at least 1000, at least 2000, at least 3000, at least 4000, at least 5000, at least 6000, at least 7000, at least 8000, at least 9000, or at least 10,000 different analytes immobilized upon the array in discrete, individually addressable locations on the array. In some cases, arrays may include at least 12,500, at least 15,000, at least 17,500, at least 20,000, at least 30,000, at least 40,000, at least 50,000, at least 60,000, at least 70,000, at least 80,000, at least 90,000, at least 100,000, at least 120,000, at least 140,000, at least 150,000, or at least 200,000 different analytes immobilized on an array in discrete locations. Thus, in many cases, the arrays described herein may provide massively large numbers of analytes immobilized and individually addressable on the array in order to not only identify the diverse numbers of different analytes, but also to be able to quantify such analytes presence within a sample. As such, any particular analyte may be present in one or more locations on an array, in a representation that may be reflective of such analyte's representation within a sample.

In certain cases, for example, an array may have disposed thereon, a representative sample of all of the proteins from a given sample, organism, cell or the like, which representative sample will include a smaller number of different types of proteins. For example, a sample may provide millions or even billions of individual protein molecules to an array, but represent only thousands or tens of thousands of different proteins. In such cases, characterization of each of the individual proteins would also allow for a quantitation of the different types of proteins on the array, and assuming the array is representative of the sample from which it is derived, then a quantitation of the proteins in the sample.

In certain particular applications, the different analytes present on arrays may include individual proteins or polypeptides, and in many cases, individual protein or polypeptide molecules, each immobilized in a discrete, individually addressable location on an array. Such protein or polypeptide arrays may generally be useful in characterizing the types and amounts of proteins present in a sample, also referred to as the proteome of the sample or organism from which the sample was taken. By characterizing individual molecules, one can not only identify those molecules, but also seek to quantify the type of protein molecule present in the sample, by identifying the level of representation of the particular type of protein molecule across the array, and then correlating that representation to the sample itself.

The above-described arrays of samples or sample components may generally be provided within a fluidic chamber or channel, e.g., as discussed for the flowcells above, with one or more fluidic inlet and/or outlet ports allowing introduction of fluid borne reagents to contact with the immobilized analytes on the arrays. Such fluidic chambers or channels may generally be referred to herein as flowcells, and may include one or more separate arrays or array regions included within the flowcell, e.g., a separate component or integrated into the flowcell or flowcell channel, itself. In some cases, more than one flowcell may be multiplexed into a single device, e.g., where a single integrated device houses at least 1, 2, 3, 4, 5, 6, 7, 8, 9, 10, 11, 12, 15, 20, 30, 50 or more discrete and separate flowcells, where absent some external connection, the different flowcells may be fluidically isolated from each other, either through separation or inclusion of barriers or valves or valving mechanisms that are able to isolate each flowcell from the others. As alluded to above, an individual flowcell unit may include multiple flowcell channels or lanes that are simultaneously accessed, e.g., for addition and removal of reagents. Likewise, a single flowcell device may include multiple fluidically discrete flowcell units, e.g., which may be differentially fluidically accessed.

Flowcells may be configured with any of a variety of different geometries, including, for example, wide chambers that have widths and lengths that are comparable, or they may include elongated, channel like chambers in which the arrays are disposed. In the case of channel-like flowcells, in order to increase the effective size of the flowcell, a flowcell may include a bend, u-turn, or serpentine geometry, in order to effectively increase the size or length of an individual flowcell without necessitating a concurrent increase in the dimensions of the overall device that comprises the flowcell, i.e., a flowcell length may effectively be increased without increasingly the length of the device that houses the flowcell, or at least without requiring an equivalent proportional increase in that length or any other dimension (length, width, or depth).

As alluded to above, multiple flowcell channels may be integrated into a single flowcell device in order to optimize throughput of the system. For example, in some cases, a single flowcell device may include 2, 3, 4, 5, 6, 7, 8, 9, 10, 11, 12 or more discrete flowcell channels integrated into a single device. In some cases, a single device may include more than 12 discrete flowcell channels, more than 20 discrete flowcell channels, more than 30 discrete flowcells, more than 40 discrete flowcell channels, or even more than 50 discrete flowcell channels integrated into a single device.

### IV. Independent Operations

In addition to providing large numbers of discrete analytes or sets of analytes for individualized analysis, as described above, the systems described herein may also often be characterized in their ability to deliver large numbers of different reagents into contact with the discrete analytes in order to carry out he analysis and/or characterization of those analytes.

The different reagents may include a variety of different reagents which are used to carry out an analysis and/or characterization of the analytes of interest, including for preparing the analytes, for interrogating the analyte, and/or for washing and/or refreshing analytes for subsequent processing and/or analysis.

As described above, the reagents included within the methods and systems described herein may include a variety of different reagent types that are capable of interacting with different analytes in ways that allow for characterization of those analytes. These reagents are generally referred to herein as interrogation reagents. For example, the reagents may include reagents that, when acted upon by the analytes, changes the characteristics of the analyte in a way that may be detected, for example as a result of incorporation or removal of a some component of the analyte, e.g., a labeled nucleotide, amino acid, or sidechain or other chemical entity, or through a modification of a chemical structure of the analyte or the interrogation reagent, e.g., opening up a ring structure, crosslinking, or the like. In some cases, the interrogation reagents may comprise affinity or binding reagents that demonstrate some level of increased propensity or affinity to binding to certain types of analytes. By way of example in some cases, e.g., where biochemical analytes include, e.g., proteins or peptides, the interrogation reagents may include affinity binding reagents such as antibodies, antibody fragments, or the like, or non-antibody protein or polypeptide binding reagents, such as aptamers, polypeptide or mini-protein affinity binding sequences, as well as other non-peptide, non-nucleic acid affinity binders, e.g., chemical binders. In some cases, affinity binding reagents may additionally or alternatively have affinity to chemical structures that may represent post translational modifications of proteins or polypeptides, such as phosphorylation, carbohydrate moieties, and the like. In some cases, the affinity reagents may be highly specific, meaning that they are highly likely to bind to a specific analyte, while being highly unlikely to bind to a different analyte, while in other cases, lower levels of specificity may be preferred, e.g., where a given affinity reagent may display some level of affinity binding across more than one specific analyte. Examples of such affinity reagents have been described in, for example, U.S. Pat. Nos. 10,473,654, and 10,948,488.

In some cases, the interrogation reagents may include at least 10 different interrogation reagents, at least 20 different interrogation reagents, at least 30 different interrogation reagents, at least 40 different interrogation reagents, at least 50 different interrogation reagents, at least 60 different interrogation reagents, at least 70 different interrogation reagents, 80 different interrogation reagents, 90 different interrogation reagents, 100 different interrogation reagents, 110 different interrogation reagents, 120 different interrogation reagents, 130 different interrogation reagents, 140 different interrogation reagents, 150 different interrogation reagents, 160 different interrogation reagents, 170 different interrogation reagents, 180 different interrogation reagents, 190 different interrogation reagents, 200 different interrogation reagents, 250 different interrogation reagents, 300 different interrogation reagents, at least 400 different interrogation reagents, at least 500 different interrogation reagents, or more.

The multiple different interrogation reagents may be contacted with the samples or sample components individually, e.g., one at a time, or they may be combined for such contact. In particular, in some cases, a single contacting step may bring a single interrogation reagent into contact with the analytes on an array. In other cases, 2, 3, 4, 5, 6, 7, 8, 9, 10, or more interrogation reagents may be contacted with the samples or sample components in a single step. In such cases, some fraction of the total number of interrogation reagents may be combined in a single solution prior to introduction to the samples or sample components, or they may be introduced as separate compositions that are intermixed while contacting the samples or sample components.

To be able to characterize binding of these affinity reagents to different molecules on an array, e.g., individual proteins, these affinity reagents may typically be provided with a detectable label. A variety of detectable label configurations may be employed, including, for example, magnetic labels, radiolabels, luminescent labels, fluorescent labels and the like. A large number of different labeling groups may be found in, e.g., the Molecular Probes Handbook (available from Thermo Fisher at https://www.thermofisher.com/us/en/home/references/molecular-probes-the-handbook.html.

Examples of certain particularly useful labeling approaches for affinity binding reagents for use in the systems and methods herein described include those described in, for example, PCT Application No. PCT/US21/58851 and U.S. Provisional Application No. 63/227,080, the full disclosures of each of which are hereby incorporated herein by reference in their entirety for all purposes. In cases where a single interrogation reagent is used at a time, one may employ single type of label group, e.g., having a single excitation and emission spectrum, whereas for multiplexed systems, i.e., where multiple interrogation reagents are contacted with an array in a single step, and detected all at once, one may include a different label group on each of the interrogation reagents used in that step, i.e., having a different excitation and emission spectra, so that they may be differentiated upon detection, e.g., using multicolor optical detection systems. I such cases, one may employ single color labels and optics, dual color labels and optics, three color labels and optics, four color labels and optics, or more.

As will be appreciated, and with reference to the proteomics applications described herein, in order to be able to characterize large numbers of different analytes, e.g., different individual proteins represented in a particular proteome or protein containing sample, immobilized on an array using affinity binding reagents, one may need to employ relatively large numbers of different affinity binding reagents that each have different specificities to different types of proteins, polypeptides, or the like. For example, and with reference to the methods described in, for example, U.S. Pat. Nos. 10,473,654, and 10,948,488, in order to characterize greater proportions of a given organisms full proteome (the full complement of proteins for a given organism, cell or tissue, at any given time), one may need to employ large numbers of differentially binding affinity reagents, e.g., greater than 10, 20, 30, 40, 50, 60, 70, 80, 90, 100, 110, 120, 130, 140, 150, 160, 170, 180, 190, 200, 250, 300, 400 500 or more different affinity binding reagents in order to more definitively characterize such larger proportions of a given proteome. Additionally, these affinity binding reagents may include antibodies, antibody fragments or derivatives, affinity polypeptides or binding proteins, aptamers, aptamer fragments or derivatives, or reagent libraries that comprise one or more of any of the foregoing types of affinity reagents, individually used to interrogate analytes, or as mixed or multiplexed subsets.

In operation, the affinity reagents may be provided within the systems described herein in different source locations that will be able to be fluidly connected to the flowcell units channels or lanes and the included arrays. As noted above, these sources may include individual affinity reagents within discrete source locations, e.g., reagent vessels, or they may be included as subsets of a reagent library, e.g., with 2, 3, 4 or more different reagents combined in a single source location. These sources may be provided as discrete sealed reagent vessels, e.g., ampules, cartridges etc., or they may be provided within multi-well plates, where each different type of affinity reagent (or pre-combined subset of reagents, as alluded to above) may be housed within a discrete well. Due to the nature of certain types of affinity reagents, in many cases, the sources of these reagents may be provided within the systems described herein, in environmentally controlled conditions, such as under refrigerated conditions, e.g., at or below 4° C., in light-controlled environments to block extraneous light from contacting the reagent source, and the like.

In addition to the large number of interrogation reagents described above, the large numbers of reagents may also include processing reagents that are to be delivered to and contacted with the samples or sample components. Examples of such reagents include, for example, wash solutions and buffers, pH adjusting buffers, stripping reagents, e.g., to remove a prior bound reagent, or a component thereof, deactivating or activating reagents, e.g., to activate a sample or sample components or a previously bound reagent or reagent component., or the like. Typically, such processing reagents may be introduced at the beginning of an overall process, e.g., to prepare an array for subsequent introduction of interrogation reagents, following introduction of an interrogation reagent, e.g., to remove excess interrogation reagent from potentially interfering with analysis, or following an analytical step, but prior to introduction of the next reagent, e.g., to reset the array, e.g., remove bound affinity reagents from an array.

The reagent sources may generally be accessible by the fluidic systems of the overall systems described herein, and as described in greater detail below. This access may include hard wired fluidic connections, e.g., where the reagent sources are coupled to fluidic manifolds that may be accessed by the fluidic system through actuation of valves, pumps and the like to deliver a desired reagent into the system at a desired time. For example, in some cases, individual reagent sources, or multivessel reagent sources, e.g., containing multiple discrete reagent vessels in a single device, may be interfaced with a manifold that provides a controllable fluid connection between the individual reagent sources and the particular fluidic system. Upon actuation, one or more reagents may be drawn into the fluidic system, e.g., through selective actuation of one or more valves or pumps coupled to the manifold. The particular reagent may then be delivered to an appropriate flowcell unit, channel or lane in a device. This selective accession and transport of different reagents may then be carried out as needed to conduct the desired analysis.

Alternatively, the reagent sources may be accessible by pipetting systems that may be inserted into the reagent sources to access the reagents and provide them into the fluidic system at the desired time. For example, a pipetting system may be inserted into a given reagent source (or in the case of multi-pipetting systems, multiple reagent sources), which would then pull the desired volume of the reagents into the pipettor(s). The pipetting system would then move to an appropriate accession point for the analytical system and deposit the reagents into the next stage of the system, e.g., an inlet port for a flowcell unit.

As discussed in greater detail below, different reagents may be provided accessible to different, independent fluidic systems, e.g., as described below, in order to accommodate different reagent needs for the system.

### A. Resource Utilization

As will be appreciated from the disclosure herein, analytical systems, and particularly complex, multiplexed analytical systems draw on multiple different resources in order to carry out their various process operations. In many cases, resources may or may not be available to different aspects or operations of the system based upon whether such resources are allocated to another part of the system, whether a certain aspect of the system is accessible by a particular resource, and depending upon the timing constraints for the given processes being carried out by the system. By way of example, in some cases, one may wish to control fluid delivery to one portion of an instrument, e.g., one or more lanes in a flow-cell. While the fluidics resources are allocated to delivering fluids to a first location, they may not be available to deliver fluid to (or remove fluid from) another location in the system. Likewise, in some cases, while reactions are being carried out in a given location, that location may not be accessible (or timing may not be appropriate) for imaging processes to be carried out in those locations. The challenges associated with resource availability and allocation in these complex analytical systems can have a substantial impact in reducing overall throughput and efficiency of these systems. The systems described herein, however, have improved the ability to provide, utilize, and stage the utilization of the various resources needed by the system, in order to significantly improve the overall efficiency of the system.

In many cases, the systems described herein provide improved efficiency by providing additional resources that may otherwise be limited in an operation. For example, in some cases, multiple independent resources of the same general type, such as fluidic systems, detection systems, environmental systems, or the like, may be applied to different locations, operations or process steps in a system, e.g., lanes in a flow-cell, locations in a lane, different flow-cells loaded into the same instrument, and/or different sources of reagents, fluids or the like. Such independent resources may be separately allocated to different operations and/or locations within the system for simultaneous operation, in performing the same or similar operations in the different locations, or in performing different operations in those different locations.

In addition to being able to provide simultaneous operations, such multiple resources may additionally provide access to a given operation or location in the system from different points, e.g., fluidic access to/from different ports in a flowcell unit or flow-cell channel, detection system observation from different sides or angles of a given location or operation, without interfering with each other or requiring more complex mechanics to move resources or the system components in order to achieve such access. Providing such multiple access points provides the ability to carry out different operations simultaneously or more immediately consecutively in some cases, allowing improvements in efficiency. By way of example, in a case where a fluidic system accesses a flowcell from one access direction, and a detection system accesses that flowcell from a different, non-interfering access point, this allows for simultaneous detection in one portion of the flowcell while fluidic operations may be carried out in another, without the need for complex robotics or other mechanical manipulations. Likewise, multiple fluidic operations, detection operations, or other processes may be carried out simultaneously, or in rapid succession by avoiding the need for repositioning of either the system component or the resources.

The availability of the above resources provides additional benefit in allowing for efficient staging of resource utilization in order to optimize timing, access, multiplexing and process requirements. In particular, as alluded to above, one may stage and schedule the different operations, e.g., fluidic introduction, fluid removal, and detection, in different portions of a system, e.g., in different lanes in a flow-cell, in order to perform the desired operations with optimal timing, and resource utilization, across the whole system, e.g., multiple lanes of the flow-cell.

### B. Independent Fluidics

As will be appreciated, given the relatively large number of reagents to be introduced into any individual flowcell device, the number of flowcell units, and the variation in the volumes and/or flow rates of those reagents being passed through individual flowcellunits, the systems described herein will, in many cases, employ more than one independent fluidic system. In particular, in some cases, the systems described herein may employ two or more independently operating fluidic systems in order to permit introduction of multiple different reagents from multiple different reagent sources into different flowcell units within a given device. In some cases, an overall system may include 3 or more independent fluidic systems, 4 or more independent fluidic systems or even 5 or more independent fluidic systems.

By way of example, a first fluidic system may be coupled with a first source of reagents, e.g., a source of a large number of interrogation reagents as described above, while a second or other additional fluidic system may be coupled to a source of other reagents, e.g., wash reagents and the like, as described above.

As described herein, independent fluidic systems may generally be characterized by the ability of one fluidic system to perform one or more different fluidic operations independently from another fluidic system. By way of example, while one fluidic system is sampling from one set of reagents and directing them to one set of fluidic locations, e.g., one or more flowcell unit, the other fluidic system may be sampling a different set of reagents and delivering them to a different flowcell unit. While performing these separate operations, these fluidic systems will generally be disconnected from each other, e.g., not fluidically connected. This disconnection may be permanent, e.g., where both systems are maintained fluidically disconnected, or it may be transient, e.g., where these fluidic systems are transiently connected to a common fluid component, but where that connection may include a valve or other mechanism to disconnect one fluidic system from the fluid component, while the other is connected to that fluid component.

In some cases, the independent fluidic systems may each be fixed in the overall system's architecture, e.g., relative to the system component it is accessing, e.g., the reagent source(s) or the flowcell device. In such cases, the manifolds, conduits and connections, e.g., to a flowcell device or unit, may be hard-wired in place. Flowcell devices could then be loaded into the system where a port on the flowcell mates with a corresponding and complementary port of the particular fluidic system. As noted above, controlling fluid access to the flowcell unit through this port is then achieved by opening valves providing fluid communication from the fluid system to the flowcell unit. Concurrently, a second fluid system may be coupled to the same, or a different port on the flowcell unit, and similarly controlled as to fluid direction through the use of valves in the fluidic system.

In addition, in some cases, while independently operated, in some cases, the independent fluidic systems may operate in a coordinated fashion. For example, in performing fluidic operations to a particular flowcell unit, direction of fluid from a first fluidic system through a flowcell unit may necessitate connection of the second fluidic system to the outlet of that flowcell unit, and actuation of the fluidic controls in that system, e.g., downstream valves and reservoirs, in order to properly direct fluid from that flowcell unit. In other cases, an independent fluidic system may include both the inlet and outlet connections and fluid paths for a given flowcell unit, so as to allow contained fluidics for each independent fluidic system.

In other cases, the fluidic systems may be mobile relative to the system component it may be accessing, such as the reagent source(s) or the flowcell device or individual flowcell units; e.g., allowing that fluidic system to be able to move to access different reagent sources and inject those reagents into different ports of a flowcell device or individual flowcell units. For example, in some cases, one or more of the independent fluid systems in the overall system may include a pipetting mechanism for sampling reagents from the source of reagents, and a translation system to which the pipettor system is attached, e.g., robotic arms, for use in moving the pipettor to an appropriate port or set of ports on a flowcell device or individual unit, or manifold or other fluidic component that is coupled to the flowcell device or individual unit, and then delivering the reagents to the flowcell through the port(s). In such cases, the fluidic system may additionally include flexible tubing and connections in order to allow for such movement.

As noted above, the different, independent fluidic systems may additionally provide reagents into flow cell devices and/or individual flowcell units at different volumes, e.g., with a first fluidic system introducing reagents into a given flowcell unit at volumes of between about 1 μl and about 1000 μl, while another fluidic system may introduce reagents into a given flowcell unit at volumes between about 1 μl and about 10 ml, 100 ml or even 1000 ml, as described above. In some cases, these fluidic systems may likewise be able to introduce reagents into a given flow cell (or discrete channels within a flow cell) at varied flow rates, for example, with one fluidic system introducing reagents into a flowcell unit at flow rates of between about 1 μl/min and about 1000 μl/min, between about 1 μl/minute and 100 μl/minute, or between about 1 μl/minute and about 10 μl/minute, while a second fluidic system may introduce reagents into the flowcell unit (or discrete channels of such flow cell) at flow rates of between about 10 μl/min and about 100 ml/min, between about 10 μl/minute and 10 ml/minute, between about 10 μl/minute and 1 ml/minute, and between 100 μl/minute and 1 ml/minute. As will be appreciated, and as alluded to previously, a given flowcell unit may include multiple interconnected flowcell channels. In such cases, it will be understood that the delivered flow rates and volumes described herein may be applicable to the individual flowcell channels within a particular flowcell unit or to the overall flowcell unit. For example, where the above described flow rates are applied to a flowcell unit that includes multiple flow channels, the flow rate introduced into the overall flowcell unit may be in a range that includes the desired channel flow rate times the number of channels in the overall flowcell device.

Accordingly, in some cases, the different fluidic systems may include a single pumping system attached to each of the more than one fluidic systems, or each fluidic system may include its own independent pumping mechanism, in order to accurately deliver significantly different fluid volumes to different flowcell units and/or at different times. For example, in cases where a given fluidic system is tasked with controllably delivering very small volumes of reagents to the flowcell units, the pumping system may employ more highly sensitive, low volume systems, such as syringe pumps or other more precise positive displacement pumping systems. Likewise, different fluidic systems may comprise different architectures. For example, in some cases, a low volume fluidic system may include a pipetting system in order to controllably deliver very small reagent volumes to the system, while higher volume reagents may be delivered using a hard-wired system, e.g., to deliver larger volume or bulk reagents to the system.

By way of example, because of their relative expense and value, interrogation reagents, such as affinity reagents, may be introduced into the flow cells of the system at relatively small volumes. In particular, these reagents may be introduced into the flowcell unit or individual flowcell channel in volume aliquots of not more than 1 μl, no more than 10 μl, no more than 50 μl, no more than 100 μl, no more than 500 μl, or even no more than 1000 μl. In some cases, the volumes of each reagent delivered by the first fluidic system may be from about 1 μl to about 1000 μl, and in some cases, from about 1 μl to about 10 μl, from about 10 μl to about 50 μl, from about 50 μl to about 100 μl, from about 100 μl to about 500 μl, and from about 500 μl to about 1000 μl. In many cases, the volumes of first reagents delievered by the first fluidic system may be from 1 μl to about 10 μl, from 1 μl to about 50 μl, or from about 1 μl to about 100 μl. Again, because these specialized reagents may include large numbers of reagents, e.g., equal to or greater than 10, 50, 100, 200, 300 or more, the fluidic system may include appropriate accession fluidics, such as a pipettor or multi-pipettor, syringe, or the like. Typically, the first fluidic system is coupled to a source of from 10 to 500 different reagents, from 100 to 500 different reagents, from 200 to 500 different reagents, or from 300 to 500 different reagents. Typically, the source of different reagents may include the individual reagents (or groups of reagents as discussed elsewhere herein), may be provided in discrete wells, compartments or reservoirs within the given overall reagent source, whereby the individual reservoirs may be individually accessed by the fluidic system to deliver the reagents contained therein to the flow cell. Such sources include, for example, multiwell plates, multicompartment cartridges, and the like.

Conversely, other reagents that are not specialized, e.g., that are used to prepare, wash, buffer, strip, etc., may typically be introduced into the flow cells or flow cell channels at volumes and flow rates that are considerably higher than for the more specialized reagents. In particular, cycles for these reagents may generally include greater volumes, e.g., from about 10 μl or 50 μl and up to 0.1 ml, up to 1 ml, up to 5 ml, up to 10 ml, up to 20 ml, or more for these reagents. As such, in many cases, the second fluidic system may generally be configured to deliver volumes of these types of reagents to the flow cell or discrete flow cell channel of from about 10 μl to about 0.1 ml (100 μl), from 50 μl to about 1 ml, from about 100 μl to about 5 ml, or in any of the foregoing cases, up to about 10 ml, 20 ml or more.

Because these reagents may not be specialized, e.g., as buffers, wash solutions, etc. there may be far fewer of these reagents needed in the system than for other types of reagents, e.g., the interrogation reagents described elsewhere herein. For example, in many cases, this second set of reagents may include from 1 to 20 different reagents, from 1 to 10 different reagents, or even from 1 to 5 different reagents.

Moreover, and as noted above, because these reagents may represent a smaller number of different reagents, e.g., less than 5, 10 or 20 different reagents, they may generally be hard-wired into their respective fluidic system, as described above. For example, in some cases, large volume reagents may be coupled to fluidic architectures that are fixed in the system, and that are controllably accessed and delivered to the flowcell units or flow cell channels using integrated valves, pumps and the like, rather than through movement of the fluidic system relative to the flowcell device. Thus, as will be appreciated, in addition to including two or more independent fluidic systems, such fluidic systems may be further differentiated in that one may be mobile relative to a flow cell, while the other is stationary relative to the flowcell device, and/or hard-wired into the overall system.

Additionally, in some cases, in order to provide for optimal staging of different reagents being introduced into different flowcell devices, units or channels at any given time, the independent fluidic systems described herein may direct reagent flows into flowcell units from different directions, e.g., as alluded to above, with one fluidic system directing reagents into a flow cell through one port of the flow cell and the other fluidic system introducing reagents through different port of the flowcell unit. By way of example, and with reference to FIG. 1, above, one fluidic system may be used to introduce one set of reagents, e.g., small volume interrogation reagents such as affinity reagents, into one port of each flowcell unit in a device. Meanwhile, a second system may be used to introduce a second set of reagents into an opposing port each flowcell unit of the device, e.g., wash reagents, at a higher volume, etc. In this mode, one may simultaneously route interrogation reagents through one flowcell unit of a device while also flowing wash reagents through a different flowcell unit, and further may do so without regard for potentially widely differing volumes and/or flow rates of fluids through their respective flowcell units. By using two fluidic systems that are independent of each other, one may more easily stage the different operations within different flowcell units in a given device. Moreover, by providing that each system may additionally access flowcell devices or units from different ports, one may more easily access the different flowcell devices or units in a single device, at any given time.

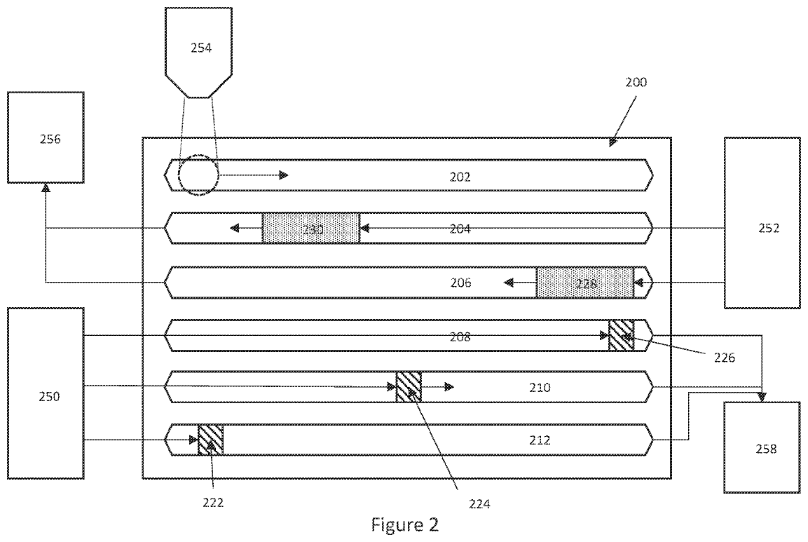

FIG. 2 provides a schematic illustration of operation of the independent fluidic systems described herein. As shown, a flowcell device 200 may include a number of flowcell units shown as channels 202-212, in which the sample components are provided immobilized in different locations. As shown, in concurrent operations, a first volume 222 of a first reagent type, e.g., an interrogation reagent, is directed through channel 212 by a first fluidic system 250. Likewise, reagent volumes 224 and 226 are directed into and through channels 210 and 208. As shown, each of volumes 222, 224 and 226 were directed into their respective channels at different times.

Concurrently with the direction of reagent volumes through channels 208-212, a volume of a different reagent 228, e.g., a wash reagent, may be directed through channel 206, with another reagent volume 230, of the same or different reagent type, being directed through channel 204, by fluidic system 252. As shown in FIG. 2, the reagent volumes 228 and 230 are shown as being of a different volume than reagent volumes 222-226, and are additionally directed into and through such channels from a different direction by fluidic system. Although illustrated as fluid volumes that are a fraction of the volume of a flow cell channel, it will be appreciated that the illustrated volumes are just indicative of differing volumes. For example, in some cases, a small volume reagent may be sufficient to fill a given flow cell channel, e.g., from about 1X to about 2X the volume of the channel, while a large volume reagent, such as a wash reagent may include enough volume to flush a channel by pushing wash reagent through the flow cell channel at 2, 3, 4, 5, 6, 7, 8, 9, 10, 20, 40, 50 or even 100 times or more the volume of the flowcell unit. As shown, reagents flowed through channels 204 and 206 may be routed to a waste receptacle or vessel, e.g., vessel 256, while reagents flowed through channels 208-210 may be passed to vessel 258. In some cases, all reagents may be flowed to a single waste vessel or receptacle, or to a disposal system.

Again, concurrently with the fluidic operations occurring within channels 204-212, an analysis system, e.g., optical analysis system 254 may be scanning and analyzing the results of reactions in yet a different channel, e.g., channel 202 (as illustrated by the dashed circle). As discussed below, the ability of the fluidics systems, and optionally, the detection or analysis system to operate independently, allows one to more efficiently stage these operations by running one or more different operations concurrently. For example, as shown in FIG. 2, an interrogation reaction, e.g., between an interrogation reagent such as a labeled affinity reagent, and a sample component, e.g., an individual protein molecule positioned within the flow cell channel, may be carried out simultaneously with the washing of interrogation reagents from other flow cells, and even the detection of the results of a completed and washed reaction in still another flow cell channel, all within the same device.

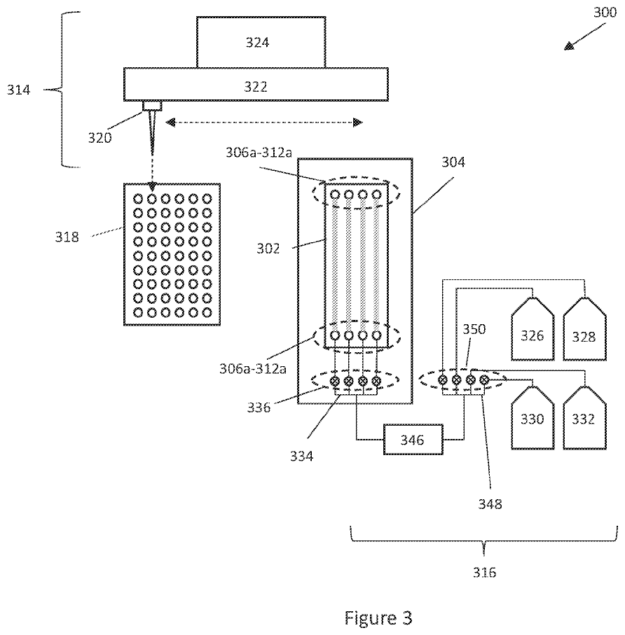

As noted above, in some cases, one of the independent fluidic systems may be mobile relative to the flow cell in the system, while the other fluidic system may be fixed or hard wired in place relative to the flowcell device or its mounting infrastructure within the overall system. An example of this is schematically illustrated in FIG. 3. As shown, the system 300 includes a flowcell device 302 mounted on a supporting stage 304, where the flowcell device includes a plurality of discrete flowcell units 306-312 contained therein. As shown, the various flowcell units each include a port at each end, e.g. ports 306a and 306b, for receiving and/or removing fluids into or out of the flowcell. The illustrated system also includes the two independent fluidic systems 314 and 316 that are able to fluidically interact with the flowcell device and its integrated flowcell units. As shown, a first fluidic system 314 is provided that is capable of accessing individual reagents form a source of large numbers of such reagents, e.g., multiwell plate 318, by moving the fluidic system's reagent sampling component, e.g., pipettor 320, into contact with the reagents within each well of multiwell plate 318. Accordingly, fluidic system 314 includes a translation system, such as robotic arm 322, for automatically moving the pipettor to each of the different wells in multiwell plate 318, as well as a pumping system 324 for drawing fluids into the pipettor 320 and dispensing them into the ports of the flowcell device. In operation, the fluidic system 314 iteratively samples different reagents from the various wells in the multiwell plate 318, moves the pipettor element 320 from the reagent sources into contact with inlet ports on individual flowcell units, e.g., port 306a (as shown by the dashed horizontal arrow), and dispenses the reagents into the port and its associated flowcell unit (as shown by the dashed vertical arrow). The system is then capable of repeating this function to the same or different flowcell units (or even additional flowcell devices) with the same or different reagents.

Conversely, as shown, second fluidic system 316 is illustrated as being fluidically coupled to a smaller number of reagent sources, e.g., reagent sources 326-332. Accordingly, the second fluidic system 316 is provided in a fixed position relative to the flowcell device 302. As will be appreciated, in the context of the illustrated system, the flowcell device will typically be mounted upon a mounting platform or station, e.g., mounting stage 304, which both secures the flowcell device into position, but also can provide some of the fluidic connections between the ports of the flowcell units in the device and one or both of the two independent fluidic systems. For example, as shown in FIG. 3, the mounting station includes a fluidic manifold 334 that provides a fluid connection between each of the individual ports 306b-312b on the flowcell device and the second fluidic system. Such manifolds, or the fluidic system itself, may additionally include valving mechanisms, e.g., valves 336, for controlling which flowcell unit of the flowcell device is accessed by the fluidic system. The second fluidic system includes a pumping system, e.g., pump 346 is itself fluidically coupled to the reagent sources 326-332. As noted above, the second fluidic system, being in a fixed position may provide a hardwired or plumbed connection with each of the ports 306b-312b, e.g., through manifold 334, as well as to the reagent sources 326-332, e.g., through an appropriate manifold or fixed tubing, e.g., manifold 348. Again, in some cases, valve systems may be included in one or both fluidic systems, in order to control which reagents are being directed to the ports of the flowcell device at any given time, e.g., as shown included in manifold 348 through valves 350. Additionally or alternatively, although illustrated as being fluidically connected (or connectable) to opposing ports of the flow channels on a flowcell unit or device, in some cases, both fluidic systems could be connected to the same ports of the flowcell unit or device. In such cases, a hardwired fluidic system (or its connected manifold) could include valve mechanisms for switching fluidic access between the first fluidic system, e.g., an inlet port accessed by the pipetting system, or the second fluidic system already coupled to the manifold.

In addition to overall systems potentially including multiple independent fluidic systems, such independent fluidic systems may include certain additional components that improve the flexibility of the system, and or provide benefits to highly multiplexed systems. For example, in certain aspects of the systems described herein one may direct fluids into and through the flowcell channels or chambers in more than one direction, e.g., flowing fluid through a flowcell unit, channel or chamber from port A to port B, while in other steps flowing fluid from port B to port A. In such cases, it may generally be desirable to avoid cross-contamination of inflowing reagents with outflowing reagents. Further, as noted above, in some cases, the fluids flowed in opposing directions may be of very different volumes, e.g., low volume reagents flowing from A to B, while high volume reagents flow from B to A. As such, in at least some cases, the ports of the flowcell lanes or interface of those ports with the fluidic system may advantageously be configured to selectively direct outflowing reagents from a particular port away from the fluid path through which additional reagents may be flowed into the flowcell unit. In addition, in some cases, a flowcell unit or device may include a port structure that allows both a small volume fluidic injection/introduction through the port, while permitting accumulation and/or removal of larger reagent volumes that have passed through the flowcell unit or device from the same port.

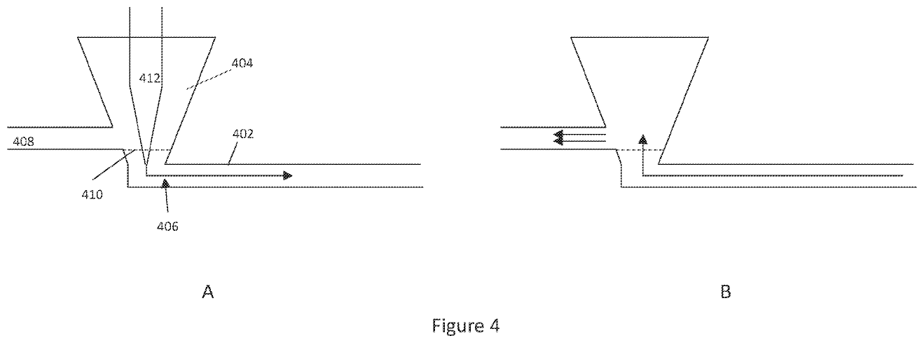

By way of example, in one aspect, a flowcell port may be provided with an evacuation port integrated into the port so that it may be used to siphon off or remove accumulated reagents that are flowed into the port through the flowcell unit or device. An example of such a structure is illustrated in FIG. 4. As shown, a flowcell channel 402 may be connected to a reservoir 404 via port 406. Reservoir 404 is also coupled to evacuation channel 408. The reservoir 404 may optionally include a septum or check valve 410 disposed across the entry to port 406, in order to prevent fluid from flowing into the port unless it is injected into the port. The check valve would serve to prevent fluid from freely flowing from reservoir 404 into port 406, unless the valve is either physically pierced or transversed, e.g., by an injector or pipette tip, or when sufficient pressure is applied to the fluid in the reservoir 404. In some cases, the valve may function as a directional check valve by allowing fluids exiting the flowcell channel 402 through port 406 to more freely flow into reservoir 404, or they may flow when such fluids are under sufficient pressure.

In operation, as shown in panel A, a sample may be injected by inserting a pipettor 412 or other injector through check valve 410 in order to drive fluid into and through flowcell channel 402. In a separate step as shown in panel B, another fluid reagent, e.g., a wash fluid, may be flowed through the flowcell channel 402 in the opposite direction (as shown by the arrows), through port 406, and past check valve 410 and into reservoir 404. As the check valve may be configured to prevent fluid from the reservoir from freely flowing back into the flowcell channel 402, the fluid will be secured in the reservoir 404. In order to ready the reservoir for a subsequent reagent introduction onto the flowcell channel 402 via reservoir 404, the fluid in the reservoir may be evacuated through evacuation channel 408, which may be coupled to a reagent disposal vessel. In some cases, the reagent disposal vessel may be under vacuum, where, upon actuation of a valve, fluids in reservoir 304 would be drawn into evacuation channel 408 and removed from reservoir 404.

In addition to the fluidic configurations described above, in at least some cases, where large numbers of reagents may be used in interrogating analytes within flowcelldevices or individual units, particularly where such reagents are used at relatively small volumes, it may be desirable to be able to preload such reagents into the fluidics system prior to introducing them into a flowcell device, e.g., in order to reduce the amount of time and volume that may be required in delivering each reagent through an entire fluidic system. In order to do this, however, it may be desirable to be able to sufficiently separate such reagents so that there is not excessive cross contamination from one reagent to the next. As such, in some cases, the fluidic system may draw reagents into the fluidic system separated by a spacer, such as a spacer fluid between reagent slugs, such as an immiscible fluid or other fluid spacer, or an air bubble or air gap in the particular fluid conduit. When combined with hydrophobic conduits, e.g., Teflon tubing, an air bubble can provide reasonably effective separation between otherwise adjacent fluid slugs. As will be appreciated however, introduction of air bubbles (and even certain spacer fluids) into flowcell channels could potentially have adverse impacts on operations carried out in the flowcells, e.g., uneven contact of reagents with analytes, etc. Accordingly, in some cases, one or more of the independent fluidic systems may include a spacer or air gap removal function prior to introduction of the reagent into the flowcell channels. In certain cases, such a function may be carried out by incorporation of a diversion path, e.g., in the form of a T junction, in or immediately upstream of the injector head or tip, in order to route the air bubble away from the injector prior to injection into the port of the flowcell channel. The diversion path may include appropriate valving that may be actuated to divert the bubble, as well as sensing system to identify the timing for such actuation. Such a sensing system may include fluidic or ionic sensors within the conduit through which the fluid is passing, or it may include an optical sensor for detecting the presence of the air gap, in order to actuate the valve at the appropriate time to divert the bubble. Other passive systems may likewise be used, e.g., gas permeable membranes, bubble trap structures, or the like.

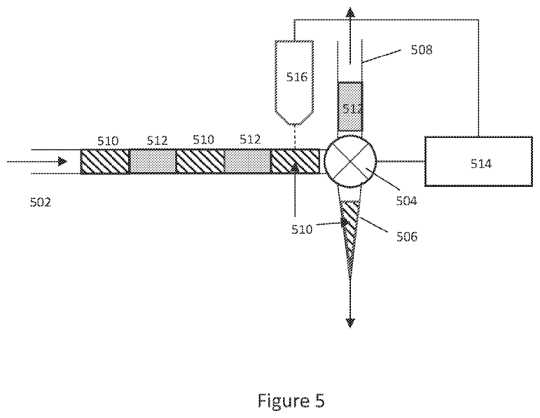

FIG. 5 provides a schematic illustration of such a system in operation. As shown, a reagent transport channel 502 is connected to a valve 504, which is also connected to the injector conduit 506 and a diversion channel 508. Upon actuation, valve 504 may direct flow from channel 502 into either injector 506 or diversion channel 508. As shown, alternating reagent slugs 510 are being transported to the injector conduit 506 separated by air gaps 512. Upon reaching the valve, the valve may be actuated to divert the air gap 512 into the diversion channel 508, and then reset to direct the reagent slug 510 into the injector conduit 506. As shown, actuation of the valve 504 is controlled by controller 514, which is connected to optical sensor 516, which can identify the presence of air gap 512 immediately before the valve 504. Controller 514 then actuates the valve to divert the air gap 512 into diversion channel 508, and resets the valve to subsequently allow reagent slug 510 to pass into the injector conduit 506

### C. Independent Detection

As with independent fluidic systems for addressing for different flowcell units or in a device (or among multiple devices), in some cases, the systems described herein may also include detection systems that are capable of analyzing detection regions in different flow cell units in a device, or different detection regions within a flowcell unit (or even different flowcell devices mounted within a larger system), while simultaneously conducting other operations, such as interrogation reagent introduction or reactions, washing, etc., in other flow cell units or regions of the same flow cell unit.

By way of example, in a flowcell device that includes multiple discrete flowcell units, one may be contacting an array in one flowcell unit with interrogation reagents, e.g., allowing biochemical reactions to occur. Meanwhile, concurrently with the occurrence of that exposure/biochemical reaction in one flowcell unit, a separate flowcell unit may be subjected to analysis, e.g., using a detection system for measuring the results of a prior interrogation reaction. This aspect of the systems is particularly useful where one is employing highly sensitive detection systems. In particular, in analytical systems that require highly sensitive detection, e.g., optical detection systems for some types of array-based analyses, the detection system may be focused on small areas of an overall device and/or individual flow cell lane.

By simultaneously carrying out fluidic operations in one set of flowcell units and detecting the results of those operations in others, one can improve the analytical throughput of the system. This improvement becomes manifold as the number of flowcell units per device or per analysis run, increases. In contrast to the foregoing, in many systems, such as high throughput DNA sequencing systems, regardless of any multiplexing of flowcell units, the fluidic operations and detection operations are typically kept discrete, e.g., with all fluidic operations being carried out in one space of time. Then, at a separate space in time, the results of those fluidic operations are detected across all of the flowcell units within a device.

In addition to enhancing the throughput of the overall analytical system, the more efficient staging of the detection operation allows for analysis of more time sensitive operations within a flow cell. In particular, as noted above, for certain analytical systems, e.g., nucleic acid sequencing systems, reaction outcomes are relatively stable, and as such, results of the interrogation reactions, e.g., stepwise addition of a labeled nucleotide in a template dependent polymerase mediated nucleic acid extension reaction, is not highly susceptible to change over any relevant timeframe between the interrogation reaction and some subsequent detection event, e.g., on the order 10 s of minutes to an hour or more. By way of example, in some current nucleic acid sequencing systems, sequencing reactions that comprise the stepwise addition of labeled nucleotides in the template directed polymerase mediated primer extension to identify the individual nucleotides in the template, are carried out within multiplexed flow cells. In these systems, reagents are typically introduced into the flow cells, e.g., for the nucleotide addition step and subsequent washing step, either in all flow cells simultaneously, or in individual flow cells. Only after these steps are completed are the flow cells subjected to analysis. In the first case, these reagent introduction and washing steps can be lengthy. Likewise, where one is staging multiple reagent steps in multiple flow cells in a device, the amount of accumulated time (and delay in performing analysis) can increase rapidly. As alluded above, this is not a critical problem in the sequencing space, where reactants tend to be more stable in these timeframes. However, in some cases, improving the throughput, reducing the time between reactions, washing and detection, can be of significant importance, in addition to simply improving efficiency.

By way of example, in a system having a detection system that analyzes a single flowcell channel at any given time, and where an interrogation reaction is followed by, e.g., a washing step prior to analysis, in one aspect, the system may stage the reaction and analysis for each flowcell channel, first performing the interrogation reaction, then the washing step, and then the analysis step. Assuming that the first step takes x minutes, the second step takes y minutes, and the third step takes z minutes, then the analysis for a given flow channel would require x+y+z minutes to complete. Where multiple flow channels are included, the amount of time would be n(x+y+z), where n is the number of flow channels in the device. Alternatively, where one possesses the requisite multiplexed fluidics, one could conduct all of the reaction and washing steps simultaneously, and then perform the analysis step in a step wise fashion across all flow cells. In this case, the amount of time required would be a much shorter x+y+n(z). However, while this latter scenario provides for a much shorter processing time for the reaction, washing and analysis of all of the flow channels, in this scenario, the amount of time that would have passed between the reaction step and the analysis step will differ substantially between the first flow channel to be analyzed and the last flow channel to be analyzed. In some cases, this variation in elapsed time can yield substantially different analytical results.

By employing independent analysis and fluidics systems (i.e., fluidic and detection resources), one may stage the reaction/washing steps immediately prior to the analysis step, progressing across the multiple flowcell units in the same device (e.g., with detection being carried out in one flowcell unit while reactions are being carried out in other flowcell units), to achieve the much shorter elapsed time of the second described scenario above, but with each flowcell units being analyzed substantially within the same timeframe from the reaction and washing steps. In particular, the amount of time required for the full analysis (assuming that detection timing (z) is as long or longer than the reagent introduction and washing steps (x+y), then the overall amount of time for an analysis of n flowcell units would be x+y+n(z), as above. Where the reagent introduction and washing steps exceed the length of the detection step (z), then the length of the overall process is n(x+y)+z.

In either instance, this timeframe is shorter than a completely serial example provided above, and allows for control of the length of time between reagent introduction (interrogation) and detection to minimize any wide variations between flowcell units and process steps. As described herein, optimizing for cinsistency of the incubation time between reagent introduction and analysis is an important benefit. As such, in certain aspects, where one is sequentially analyzing the results of an interrogation reaction process in a plurality of flowcell units in a single integrated device, or with a single detection system, one can be carrying out those interrogation reactions in a staged manner so that the timing between the completion of the a interrogation reaction process and the beginning of the associated analysis is substantially the same in each flowcell unit, e.g., no more than 20% timing difference, no more than 10% timing difference (i.e., shorter or longer), no more than 5% timing difference, no more than 3% timing difference, or no more than 1% timing difference. As will be appreciated, the consistency of timing may apply to all interrogation reactions or like interrogation reactions, e.g., where different interrogation reactions, e.g., involving different interrogation reagents, have different desired incubation times, such that it some cases, a set of like reactions involving a particular reagent or type of reagents in different flowcell units experiences the same desired incubation time as other flowcell units.

To illustrate the above-described efficiency advantages, FIG. 5 provides a schematic of timing for delivery of different reagents to a number of different flowcell units within a flowcell device, followed by detection of reaction results in each flowcell unit. In particular, FIG. 5 provides a schematic illustration of a given timeline of events with respect to each of several different flowcell units within an integrated device. In the example illustrated, two different interrogation reagent cycles are introduced to each of twelve different flowcell units in a single device, interspersed with introduction of other necessary reagents, and including detection steps following each cycle with full utilization of the detection system, e.g., with little or no down time.

In particular, FIG. 5 illustrates the timeline of operations for an analysis. For ease of discussion, the discussion of FIG. 5 refers to analysis of arrays of single protein molecules disposed in the different flowcell units, where those arrays are to be interrogated by a series of different fluorescently labeled affinity reagents which bind differentially to different proteins or portions of proteins. The arrays included in each of the flowcell units are then analyzed using an optical detection system to identify the proteins to which each affinity reagent binds in the array, in order to characterize the different proteins present.

As shown in FIG. 5, a timeline is shown for each of 12 different flowcell units in a single integrated device as reagents are introduced into those flowcells and subsequent analysis takes place over two cycles of interrogation reagent introduction. As shown, a first preparatory reagent, e.g., a reagent that ensures that no interfering agents are present and/or bound to the proteins in the array that might potentially interfere with binding of the interrogation reagents, is introduced into a first flowcell unit (channel A) in an operation that takes a first period of time (1). This first reagent is then allowed to incubate within that flowcell unit for an additional period of time (2). During this incubation period (2), the fluidic system(s) can begin introducing the preparatory reagent into subsequent flowcell units, e.g., channels B, then C, then D, etc.). Following the incubation period (2), a wash reagent may be flowed through the flowcell unit for a period of time (3). Following that wash period (3), a first interrogation reagent, such as a labeled affinity reagent, may be introduced into the flowcell unit during time period (4) and allowed to contact the proteins in the array within the flowcell unit. Again, this interrogation reagent is then allowed to incubate within the flowcell unit (channel A) for a period of time (5) suitable to allow for interaction with the elements of the array, e.g., the proteins.

As before, during these previous operations, the fluidic systems are able to carry out these operations in the next channels of the device in a staged fashion, e.g., in channels B, C, D, etc., but in a manner that overlaps with the operations in the other channels, to optimize efficiency of operation of the fluidics systems. Following the incubation period (5) a second wash reagent is introduced into the flowcell unit to flush out unbound the interrogation reagent during a period (6). After this wash step, the detection system, e.g., an optical detection system, may be directed to the first flowcell unit to ascertain the presence or absence of bound interrogation reagent during period (7), e.g., detecting the presence of fluorescently labeled, bound affinity reagent, and the location in the array to which it bound. Once the detection step is completed in the first channel (A), it may be commenced in the second channel (B), and so on.

This process is then repeated within the same flowcell unit, and within each other flowcell unit in the same manner, but using a different interrogation reagent (indicated as period 4′ in flowcell unit channel A).

As shown, multiple different operations may be carried out in different flowcell units within a single device at the same time. For example, in one subset of flowcell units, interrogation reagents may be introduced, while wash reagents and prep reagents are introduced in others. Likewise, incubation steps may be carried out in other flowcell units. Finally, analysis can commence in another flowcell unit or subset thereof concurrently with any or all of the above operations in other flowcell units, within the same device.

As noted, this staging allows stepwise initiation of each operation in each flowcell unit, without needing to wait for any one operation to be completed in all flowcell units before commencing the next operation, and where each flowcell unit is experiencing the same or substantially the same operations and timing. This includes both reagent introduction steps and detection analysis steps. As a result, one may gain efficiency of optimizing duty cycles of the fluidics systems and detection systems, and improves the throughput of the overall system, while allowing for better control between reagent introductions and analysis. For example, as shown, one can step the detection system across each individual flowcell unit within the same device, while ensuring that the elapsed time between interrogation and detection in each unit remains substantially the same.

As will be appreciated, in the staging shown in FIGS. 2 and 5, described above, an interrogation reaction may be occurring within one flowcell unit within the device (and/or a washing step may be occurring in another flowcell unit within the device), the analysis may be occurring simultaneously with respect to yet a different flowcell unit within the same device. By accommodating such simultaneous reactions/processing in one subset of flowcell units, channels or lanes, while simultaneously analyzing results in other subset(s) of the device, one can optimize the use of the detection system and minimize downtime and overall processing time for the systems described herein.

In some cases, a scheduling process may be employed that operates by taking the different process steps from a perspective of the different operations each having a known timing requirement. The resources required for each operation are then identified, and a greedy scheduling algorithm is applied in order to determine the start time of each operation, subject to the restraints that exist on the resources that are needed for the overall analysis to be carried out by the system. The various resources are then assigned and reserved for the different operations as is appropriate for the overall process being performed. For example, with respect to the example provided above, the low volume reagent introduction step requires certain timing and resources (e.g., a low volume fluidic system), while the washing steps have different timing requirements and require a separate resource (e.g., a second, high volume fluidic system). Lastly, analysis requires focusing the detection optics on a given flow cell lane timed to occur within a certain timeframe following the reaction carried out therein (e.g., using the low volume reagents that are subsequently washed by the high-volume reagents), using the additional resource of the detection system. By applying a greedy algorithm to these steps and resources, and the desired timing requirements, one can optimally stage the application of these different resources across the various flow cell lanes in the system, e.g., as shown in FIG. 5, to optimize processing efficiency in the system.

Although described with reference to certain specific examples, it will be appreciated that variations to the systems and methods described herein may be practiced within the scope of the appended claims.

1-19. (canceled)

20. A method for analyzing a plurality of analytes, comprising:
providing a plurality of flowcell units in a flowcell device, each flowcell unit having an array of analytes disposed therein;
performing an interrogation reaction process on the arrays of analytes in each of a subset of flowcell units in the plurality of flowcell units by passing one or more interrogation reagents through each subset of flowcell units;
serially detecting a result of the interrogation reagents on the analytes in the arrays in each of a plurality of subsets of the flowcell units; and
repeating the performing and detecting steps on each subset of the plurality of flowcell units;
wherein the performing steps and the detecting steps are staged such that an elapsed time between completion of the performing step and beginning of the detecting step for any flowcell unit is substantially equivalent.

21. The method of claim 20, wherein between each of the performing steps and the detecting steps, a wash reagent is introduced into each of the flowcell units to carry out a washing step.

22. The method of claim 21, wherein interrogation reagents for performing the interrogation reaction, and wash reagents for performing the washing step, are introduced into the flowcell device using a plurality of independent fluidic systems.

23. The method of claim 21, wherein for a given flowcell unit, the detection step is longer than a combined duration of the interrogation reaction and washing steps, and a length of time to perform a cycle of interrogation reaction, washing and detection steps is equal to x+y+n(z), where x and y, respectively, are a duration of the interrogation and washing steps, z is a duration of a detection step, and n is a number of flowcell units for such cycle.

24. The method of claim 21, wherein for a given flowcell unit, the detection step is shorter than a combined duration of the interrogation reaction and washing steps, and a length of time to perform a cycle of interrogation reaction, washing and detection steps is equal to n(x+y)+z, where x and y, respectively, are a duration of the interrogation and washing steps, z is a duration of a detection step, and n is a number of flowcell units for such cycle.

25. The method of claim 20, wherein the plurality of flow cell units comprises at least 4 flowcell units, and wherein the performing step comprises serially performing the same interrogation reaction in each of the at least 4 flowcell units and the detecting step comprises serially detecting results of the interrogation reaction in each of the at least 4 flowcell units.

26. The method of claim 20, wherein the plurality of flow cell units comprises at least 6 flowcell units, and wherein the performing step comprises serially performing the same interrogation reaction in each of the at least 6 flowcell units and the detecting step comprises serially detecting results of the interrogation reaction in each of the at least 6 flowcell units.

27. The method of claim 20, wherein the plurality of flow cell units comprises at least 12 flowcell units, and wherein the performing step comprises serially performing the same interrogation reaction in each of the at least 12 flowcell units and the detecting step comprises serially detecting results of the interrogation reaction in each of the at least 12 flowcell units.

28. The method of claim 20, wherein the performing and detecting steps are repeated with at least 50 different interrogation reagents.

29. The method of claim 20, wherein the performing and detecting steps are repeated with at least 100 different interrogation reagents.

30. The method of claim 20, wherein the performing and detecting steps are repeated with at least 200 different interrogation reagents.

31. The method of claim 20, wherein the performing and detecting steps are repeated with at least 300 different interrogation reagents.

32. The method of claim 20, wherein the performing and detecting steps are repeated at least 50 times with different interrogation reagents or combinations of interrogation reagents.

33. The method of claim 20, wherein the performing and detecting steps are repeated at least 100 times with different interrogation reagents or combinations of interrogation reagents.

34. The method of claim 20, wherein the step of performing an interrogation reaction in a first subset of flowcell units is carried out concurrently with the step of detecting the result of an interrogation reaction in a second subset of flowcell units.

35. The method of claim 20, wherein the elapsed time between the completion of the performing step and the beginning of the detecting step in a first flowcell unit is no more than 20% different from the elapsed time between the completion of the performing step and the beginning of the detecting step in a second flowcell unit.

36. The method of claim 20, wherein the elapsed time between the completion of the performing step and the beginning of the detecting step in a first flowcell unit is no more than 10% different from the elapsed time between the completion of the performing step and the beginning of the detecting step in a second flowcell unit.

37. The method of claim 20, wherein the elapsed time between the completion of the performing step and the beginning of the detecting step in a first flowcell unit is no more than 3% different from the elapsed time between the completion of the performing step and the beginning of the detecting step in a second flowcell unit.

38. The method of claim 20, wherein the array of analytes comprises a single molecule protein array, and the plurality of interrogation reagents comprises a plurality of affinity reagents having affinity to different proteins.

39. A system for analyzing proteins, comprising:
a flowcell unit comprising a single molecule protein array;
a source of at least 300 different affinity reagents;
a first fluidic system fluidicly coupled to the flowcell unit and configured to access each of the 300 different affinity reagents in the source of at least 300 different regents;
a detection system positioned relative to the flowcell unit to detect binding reactions between the affinity reagents and proteins on the single molecule array;
a controller coupled to the fluidic system and detection system, and configured to serially deliver each of a plurality of individual affinity reagents to the flowcell unit, and detect binding of each of the individual affinity reagents to one or more proteins on the single molecule array, such that an elapsed time between delivering affinity reagents to the flowcell unit and detection of binding of affinity reagents to one or more proteins on the single molecule array is substantially equivalent.
